(19) United States
(12) Patent Application Publication
(10) Pub. No.: US 2023/0262769 A1
(43) Pub. Date: Aug. 17, 2023

(54) SINGLE CHANNEL P2P COMMUNICATION FOR MLDS

(71) Applicants: SONY GROUP CORPORATION, Tokyo (JP); SONY CORPORATION OF AMERICA, New York, NY (US)

(72) Inventors: Li-Hsiang Sun, San Jose, CA (US); Mohamed Abouelseoud, Burlingame, CA (US); Liangxiao Xin, Santa Clara, CA (US); Qing Xia, San Jose, CA (US)

(73) Assignees: SONY GROUP CORPORATION, Tokyo (JP); SONY CORPORATION OF AMERICA, New York, NY (US)

(21) Appl. No.: 18/165,805

(22) Filed: Feb. 7, 2023

Related U.S. Application Data
(60) Provisional application No. 63/267,958, filed on Feb. 14, 2022.

(51) Int. Cl. H04W 74/08; H04L 5/00

(52) U.S. Cl. CPC H04W 74/0816; H04L 5/0053; H04W 84/12

(57) ABSTRACT

In a MU-RTS TXS based P2P access allocation, there can be frames sent in legacy format (such as control frames in non-HT format) that do not carry a Basic Service Set Identification (BSSID) in its address fields. The Duration setting of the frames may cause a next station to be scheduled to set the basic NAV because the next station categorizes these frames as inter-BSS PPDUs. To prevent the next station from not responding to the AP's next allocation, the Duration setting of the frames are set so that they are not greater than the end time of the P2P allocation that occurs prior to the next allocation.

### CROSS-REFERENCE TO RELATED APPLICATIONS

This application claims priority to, and the benefit of, U.S. provisional patent application Ser. No. 63/267,958 filed on Feb. 14, 2022, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless local area networks on IEEE 802.11, and more particularly to improve handling of Peer-To-Peer (P2P) traffic on a wireless network having Multi-Link Devices (MLDs).

### 2. Background Discussion

Wireless networking between stations (AP or non-AP) of Multi-Link Devices (MLDs) is performed in IEEE 802.11, including Peer-To-Peer communications. The stations of the MLD may be either configured for Simultaneous Transmit and Receive (STR), or unable to simultaneously transmit and receive and are called NSTR stations.

Current wireless protocols do not fully utilize station resources for the benefit of P2P stations.

Accordingly, a need exists for enhanced 802.11 protocols which make improved use of resources and interfacing with NSTR devices to the benefit of P2P operations. The present disclosure fulfills those needs and provides additional benefits.

### BRIEF SUMMARY

A protocol is described for IEEE 802.11 with improved use of network resources in handling Peer-To-Peer (P2P) traffic. Mechanisms are described for performing bandwidth negotiation between a station (STA) and the Access Point (AP) for allocated P2P Service Periods (SPs). Dynamic coordination is provided between the AP and P2P MLD, which address NSTR constraints, especially when both P2P traffic and network traffic are present. A setup procedure is also provided to coordinate between an AP and the P2P MLD, and for resolving NAV blocking of later allocations after an allocation for a P2P communication.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a communications diagram of a non-AP MLDx having a Tunneled Direct Link Setup (TDLS), as performed according to at least one embodiment of the present disclosure.

FIG. 4 is a communications diagram of the non-AP MLDx using the TDLS, with the AP sending a Delay-To-Send (DTS) frame to suggest a Backoff (BO) to the TDLS peer station, as performed according to at least one embodiment of the present disclosure.

FIG. 5 is a communications diagram of the non-AP MLDx using the TDLS, with the AP determining not to send DL PPDUs on the other links, as performed according to at least one embodiment of the present disclosure.

FIG. 6 is a communications diagram of an NSTR link pair and the alignment of PPDUs, as performed according to at least one embodiment of the present disclosure.

FIG. 7 is a communications diagram of a non-AP MLDx having a TDLS link with MLDx starting an UL PPDU to AP MLD, as performed according to at least one embodiment of the present disclosure.

FIG. 8 is a communications diagram of an AP acquiring a TXOP by a CTS to Self (CTS2Self) frame and allocating a first portion of the TXOP by using MU-RTS TXS for P2P communication, as performed according to at least one embodiment of the present disclosure.

FIG. 9 is a communications diagram of an AP transmitting MU-RTS for assigning an allocation period for P2P communications, performed according to at least one embodiment of the present disclosure.

FIG. 10 is a communications diagram of a non-AP STA performing a P2P setup with a P2P peer and a P2P TWT agreement with another P2P peer, as performed according to at least one embodiment of the present disclosure.

FIG. 11 is a network topology of interactions between an AP MLD, non-AP MLDx, and non-AP MLDy, according to at least one embodiment of the present disclosure.

FIG. 12 is a flow diagram of an AP receiving and processing an initial frame from an MLD or STAx being sent to a MLD or STAy, as performed according to at least one embodiment of the present disclosure.

FIG. 13 and FIG. 14 is a flow diagram of a non-AP MLD handling an initial frame, as performed according to at least one embodiment of the present disclosure.

FIG. 15 and FIG. 16 is a flow diagram of an AP MLD handling an NSTR link pair and the alignment of PPDUs, as performed according to at least one embodiment of the present disclosure.

FIG. 17 and FIG. 18 is a flow diagram of a non-AP MLD handling an NSTR link pair and the alignment of PPDUs, as performed according to at least one embodiment of the present disclosure.

FIG. 19 is a data field diagram of an AP Advisory Frame, according to at least one embodiment of the present disclosure.

FIG. 20 is a data field diagram of a Control field in a TWT element, according to at least one embodiment of the present disclosure.

FIG. 21 is a data field diagram of an Individual TWT parameter set field, according to at least one embodiment of the present disclosure.

FIG. 22 is a data field diagram of a Request Type field in a Broadcast TWT Parameter Set field in a TWT element, according to at least one embodiment of the present disclosure.

FIG. 23 is a data field diagram of a Broadcast TWT Parameter used for a R-TWT request, according to at least one embodiment of the present disclosure.

### DETAILED DESCRIPTION

1. Problem in Current State of the Art

In single channel wireless communications under IEEE802.11, the AP does not receive feedback on whether the allocated peer-to-peer (P2P) Service Period (SP) is being fully utilized. There is a lack of dynamic coordination between the AP and P2P Multi-Link Device (MLD) toward preventing violations of Non-Simultaneous Transmit-Receive (NSTR) constraints when P2P traffic and network traffic are present. There is also a lack of setup procedures to provide static coordination between the AP and the P2P MLD, so as prevent NSTR constraint violations, when P2P traffic and network traffic are present. Issues regarding NAV blocking arise on later allocations after a Single User (SU) allocation for P2P.

2. Contribution of the Invention

The present disclosure provides mechanisms for performing bandwidth negotiation between a STA and the AP for the AP allocated P2P SP. Dynamic coordination is provided between the AP and P2P MLD so as not to violate NSTR constraints when P2P traffic and network traffic are present. A Setup procedure is also described for providing coordination between the AP and the P2P MLD so as not to violate NSTR constraints when P2P traffic and network traffic are present. In addition, the teachings of the present disclosure provide for resolving NAV blocking of later allocations after a P2P allocation.

3. Hardware Embodiments

3.1. Communication Station (STA and MLD) Hardware

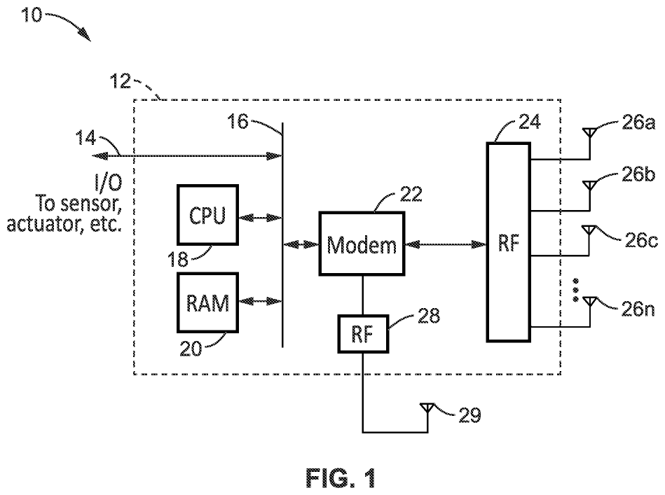

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

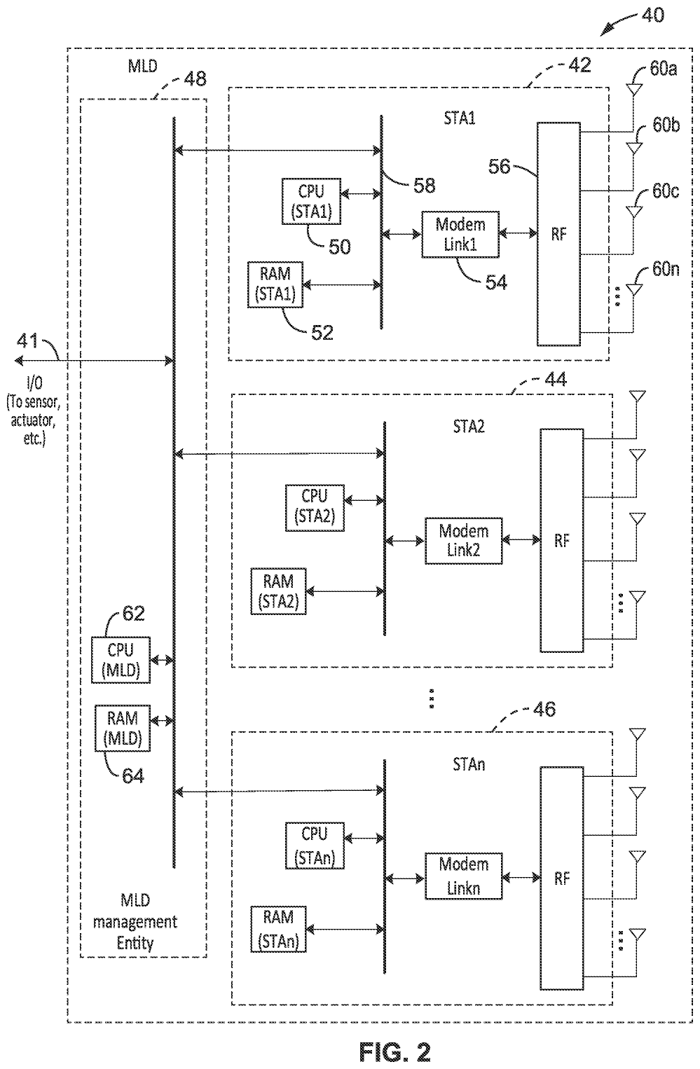

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

4. Embodiments of the Present Disclosure

A description of embodiments and their inter-relationships are contained in Section 5. The following descriptions of the various embodiments makes numerous references to this detailed hierarchical description.

4.1. Example Communications

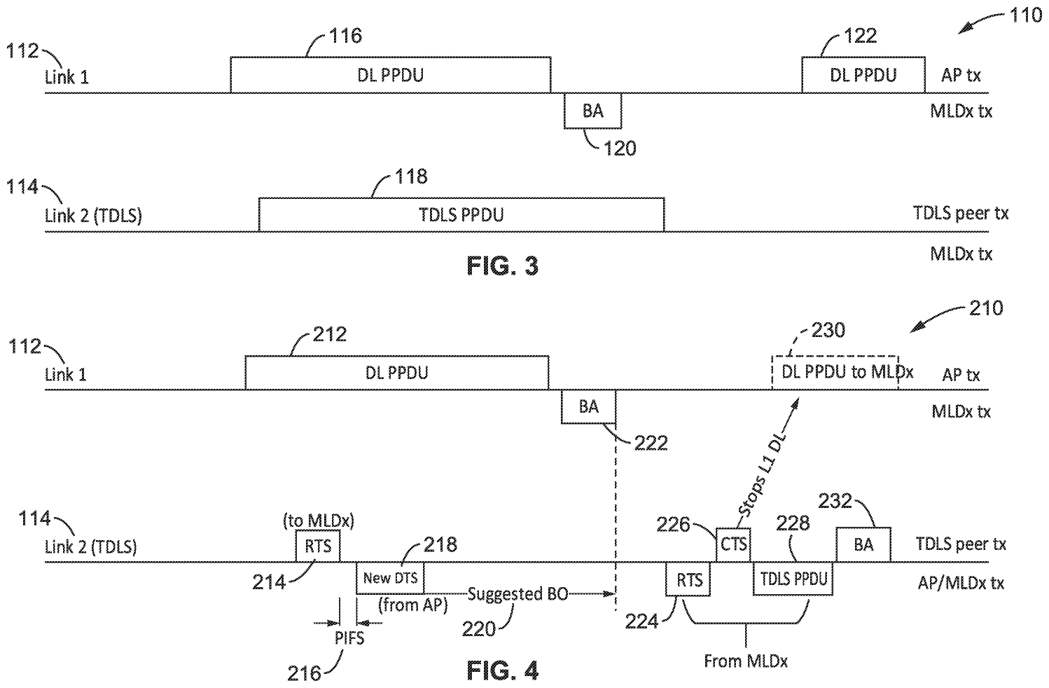

FIG. 3 illustrates an example embodiment 110 of a non-AP MLDx having a Tunneled Direct Link Setup (TDLS) on link2 114. Both link1 112 and link2 114 are associated with an AP MLD. Link1 and link 2 are NSTR link pairs for the non-AP MLDx. Link2 is shown also being utilized by a TDLS PPDU peer transmission and a MLDX transmission.

After receiving a DL PPDU 116 on link 1, the Block Ack (BA) 120 transmitted by MLDx on link1 interferes with the reception of TDLS PPDU 118 from the TDLS peer on link2. DL PPDU 122 as later transmitted to MLDx may again cause the NSTR self-interference at the MLDx, because the AP MLD is not aware of the TDLS activity associated with the MLDx on link 2.

FIG. 4 illustrates an example embodiment 210, showing the same link1 112 utilized by the AP and MLDx, and link2 114 utilized by the communication between the AP and MLDx, and between MLDx and a TDLS peer station. This mechanism is described in element 6 of Section 5, and is utilized by the TDLS peer of the MLDx on link 2 (TLDS) to send an initial frame RTS 214 to MLDx during DL PPDU 212 on link 1.

MLDx, which is receiving DL PPDU from AP MLD on link 1, does not reply to Ready-To-Send (RTS) 214 with a CTS. According to element of 8 in Section 5, a determination is made based on the Receiver Address (RA) of the RTS, and the fact of not receiving a CTS after Short Interframe Spacing (SIFS) 216 of the RTS, so that the AP may optionally send a Delay-To-Send (DTS) frame 218, after PIFS 216, which communicates a suggested backoff delay 220 to the TDLS peer. The suggested backoff may be based on the remaining TXOP on link 1 with the MLDx. The MLDx transmits a BA 222 to be completed by the end of the TXOP.

If the TDLS peer is a legacy HE STA, it would send RTS to MLDx on link 2 because the AP is indicating a small value in the TXOP Duration RTS Threshold subfield in the HE Operation Parameters field in the HE Operation element. In this case the AP may not reply with the DTS frame because the legacy STA would not understand this new frame.

Then MLDx sends an initial frame RTS 224 according to element 5 Section 5, and receives a CTS 226 from the TDLS peer. The AP MLD may base its decision on the TA of the RTS or the RA of the CTS, and the NAV of RTS/CTS, in determining not to send DL PPDU 230 to MLDx on link 1 in the NAV duration to avoid interfering with TDLS communication on link 2. Then the MLDx transmits a TDLS PPDU 228, and receives BA 232 from the TDLS peer.

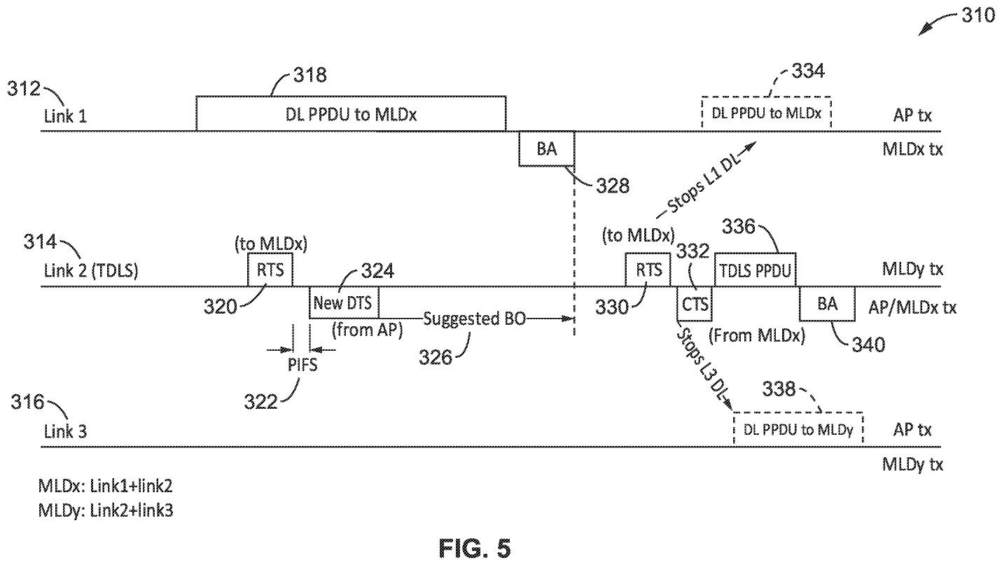

FIG. 5 illustrates an example embodiment 310 of a non-AP MLDx having a TDLS link on link2 314 for communication with MLDy, and link1 312 and link2 314 are associated with an AP MLD. Link1 and link 2 are NSTR link pairs for the non-AP MLDx. The non-AP MLDy has a TDLS link on link 2 for communication with MLDy, and link 2 and link 3 are associated with the AP MLD. Link 2 and link 3 are NSTR link pairs for the non-AP MLDy.

The first portion of the figure is the same as shown in the first part of FIG. 4, in which MLDx is receiving a DL PPDU 318 from AP MLD on link1, and thus does not reply to RTS 320 from MLDy with a CTS. Instead, the AP may optionally send a DTS frame 324 after PIFS 322, and suggest a backoff 326 to the TDLS peer MLDy. The MLDx transmits a BA 328 which is completed by the end of the TXOP.

Then MLDy sends an initial frame RTS 330 according to element 5 Section 5, and MLDx replies with a CTS frame 332. Based on the TA of the RTS, or the RA of the CTS, and the NAV of RTS/CTS, the AP MLD may decide to stop sending DL PPDU 334 on link 1 to MLDx, and/or DL PPDU 338 to MLDy within the NAV duration to avoid interfering with TDLS peer communication. MLDy is seen transmitting TDLS PPDU 336, which is acknowledged with a BA 340 by the AP/MLDx.

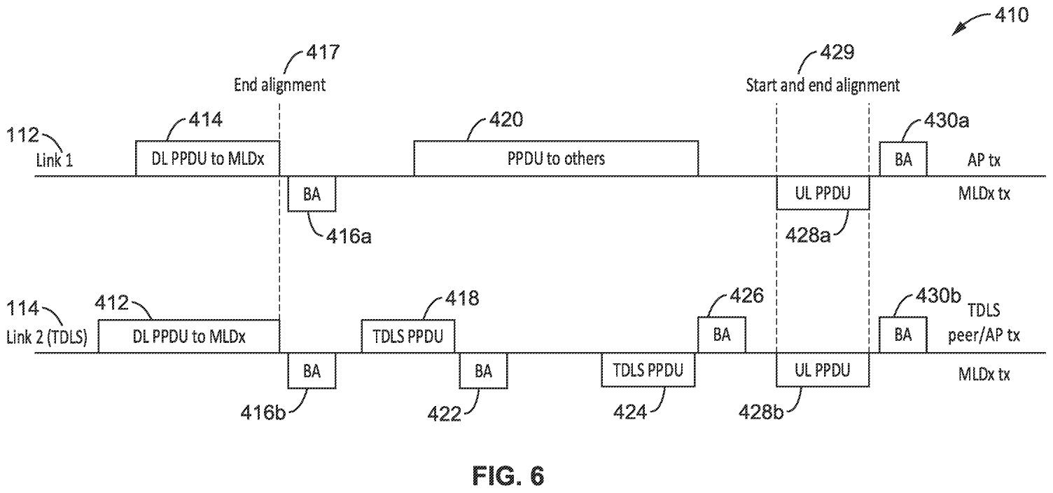

FIG. 6 illustrates an example embodiment 410 of a non-AP MLDx having a TDLS link on link2 114. Both link1 112 and link2 114 are associated with an AP MLD. Link1 and link 2 are NSTR link pairs for the non-AP MLDx. Link 2 is designated as an anchor link for MLDx by AP MLD and MLDx according to element 9 of Section 5. It will be noted that an anchor link is a link such that when communication occurs between a non-AP MLD and an AP MLD on a link NSTR to the anchor link, then the anchor link is CCA busy for any potential P2P or TDLS peer, for instance the communication between the AP and non-AP MLD also occurs on the anchor link to keep the anchor link CCA busy. The anchor link may be the TDLS/P2P link for the non-AP MLD. The mechanism keeps the P2P peer from initiating transmission to the non-AP MLD on the anchor link when there is traffic to or from the AP on the non-anchor link.

The AP starts transmission of DL PPDU 412 on anchor link 2 to MLDx, and the second part of the condition of element 9(a) of Section 5 is satisfied: any time a PPDU is sent between (MLDx, AP MLD) on any link NSTR paired with the anchor link, there should be another PPDU on the anchor link from the MLDx or AP, for example the P2P peer is Clear-Channel-Assessment (CCA) busy on the anchor link. Therefore, since this is fulfilled, the AP MLD may also start a DL PPDU 414 to MLDx on link1, while providing for end alignment 417 of both PPDUs according to element 9(c); whereby if the PPDUs on both links (the P2P link and a link y that is NSTR paired with the P2P link) are sent to the MLDx, then the end time of each of these PPDUs should be approximately aligned.

During the TDLS PPDU transmission to/from MLDx, the anchor link is CCA busy. The AP during this period may not transmit to the MLDx according to element 10(d) of Section 5: If the AP is not in a TXOP on the anchor link, then the AP MLD may simplify the procedure further by not transmitting a PPDU to the MLDx on a link which is NSTR paired with anchor link; or element 10(e) of Section 5: wherein an AP MLD may simplify the procedure further by not transmitting a PPDU to the MLDx on a link which is NSTR paired with the anchor link, if the AP is not a TXOP holder on the anchor link. The MLDx is seen sending BA 416a, 416b in response to receiving these DL transmissions.

When the anchor link is CCA busy because of a TDLS PPDU 418, 422, 424, 426 to the MLDx, then the AP may transmit a PPDU 420 to other stations on link 1, and these other stations do not have link 2 as an anchor link (e.g., they are not used for the P2P communications of the station).

When MLDx sends UL PPDU 428a on link1 to AP MLD, it also keeps anchor link CCA by sending another UL PPDU 428b to the AP. Because the 2 links are NSTR pair for MLDx, the start time of the UL PPDU 428a and 428b must be aligned because if one link starts earlier it would cause the other link CCA busy due to self-interference and blocking the transmission of the other link. The end time of UL PPDU 428a and 428b are also aligned so both links can switch to receiving BA 430a, 430b.

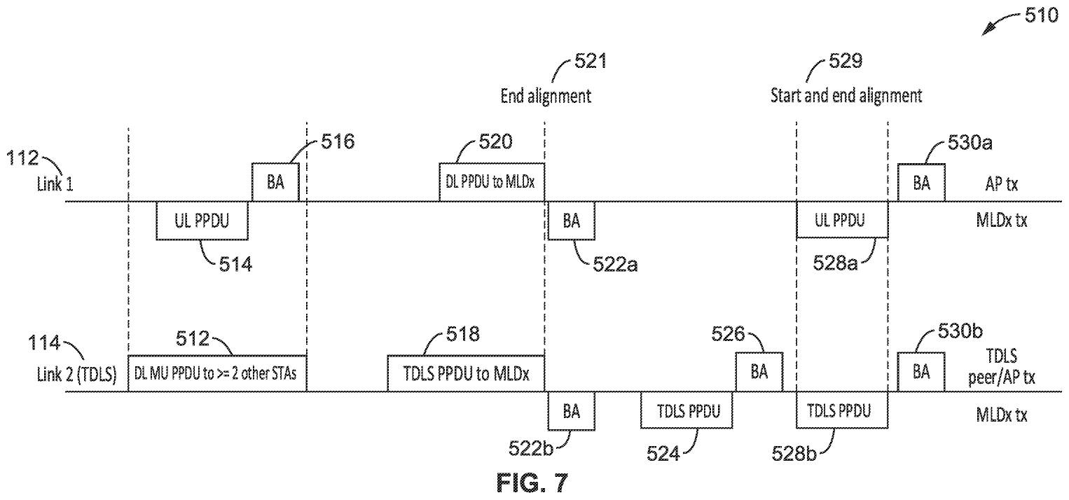

FIG. 7 illustrates an example embodiment 510 of a non-AP MLDx having a TDLS link on link2 114. Both link1 112 and link2 114 are associated with an AP MLD. Link1 and link 2 are NSTR link pairs for the non-AP MLDx. Link 2 is designated as an anchor link for MLDx by the AP MLD and MLDx according to element 9 of Section 5.

The AP on the anchor link sends a DL MU PPDU 512 to STAs that are not affiliated with MLDx; whereby the second part of the condition on element 9(a) of Section 5 is satisfied, in which either initiator or responder is an AP (i.e. sender of the DL MU PPDU to two or more STAs must be an AP) causing CCA busy on the anchor link; so MLDx may start an UL PPDU 514 to the AP MLD on link1, and its receipt is acknowledged with BA 516.

Because TDLS PPDU can be a DL MU PPDU, the MLDx may consider that a received DL MU PPDU is from the associated AP (e.g., not a TDLS PPDU) based on the DL flag, color matching BSS color, and destination station information of more than one STA included in the MU PPDU preamble. The TDLS peer on the anchor link sends a TDLS PPDU 518 to MLDx, and the second part of the condition of element 9(a) of Section 5 is again satisfied, so the AP MLD may send a DL PPDU 520 to MLDx on link1 with the PPDUs being end aligned 521, according to element 9(c) of Section 5. BAs 522a and 522b are seen acknowledging these transmissions. The AP MLD may detect a received MU PPDU as from a TDLS peer of MLDx based on the DL flag, color matching BSS color, and information from one STA addressed to the MLDx included in the MU PPDU preamble.

MLDx sends a TDLS PPDU 524 to the TDLS peer; however, as the second part of the condition of element 9(a) may not be satisfied from the viewpoint of the AP MLD, as the preamble of the TDLS PPDU preamble does not identify the MLDx. Therefore, the AP MLD does not send a PPDU on link1 to MLDx while the TDLS PPDU is ongoing. A BA 526 is seen being received for TDLS PPDU 524.

If the AP MLD is able to decode the MAC header of a MPDU in the TDLS PPDU, and finds a TA matching the link 2 MAC address of MLDx, then the second part of the condition on description 9(a) is satisfied, however the AP still cannot send to MLDx on link 1 due to blindness caused by the NSTR condition.

MLDx sends a TDLS PPDU 528b to the TDLS peer, and the second part of the condition on description 9(a) is satisfied from the point of view of MLDx, so it may also start a UL PPDU 528a on link 1 according to link 1 EDCA backoff counter 0 with start/end alignment 529 between the two PPDUs. These PPDUs are acknowledged with BAs 530a and 530b.

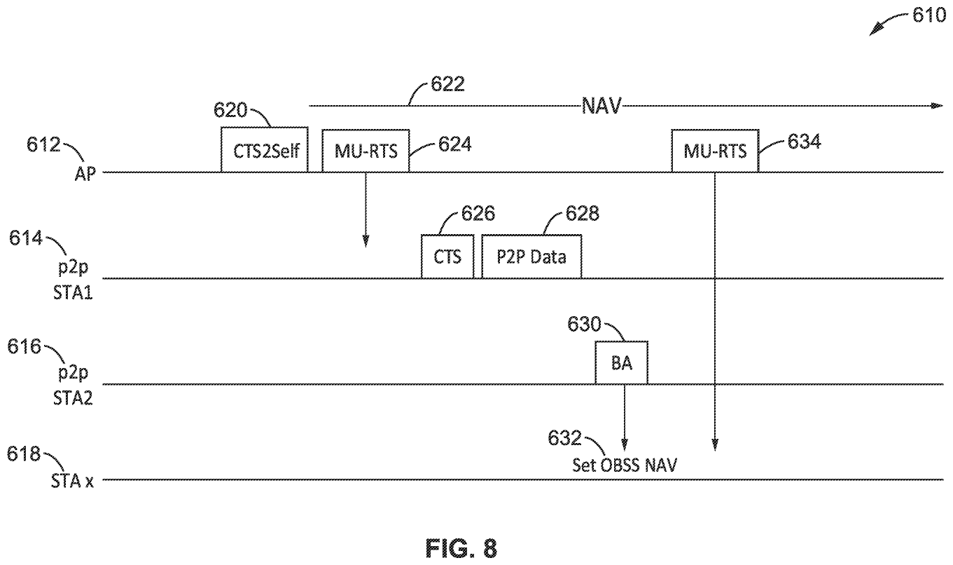

FIG. 8 illustrates an example embodiment 610 of an AP acquiring a TXOP by a CTS to Self (CTS2Self) frame 620, with associated NAV 622, and allocating a first portion of the TXOP by using MU-RTS TXS 624 to STA1 for P2P communication on the same link. The figure shows interaction between an AP 612, P2P STA1 614, P2P STA2 616, and STAx 618. Then STA1 is seen sending a CTS, and sending P2P Data 628 to STA2 as the P2P peer of STA1. Upon receiving the P2P Data STA2 sends BA 630 to STA1. The BA is transmitted using non-HT (duplicate) PPDU format. The Duration field of the BA 630 sets 632 the OBSS NAV on the STAx which has scheduled a second portion of the TXOP by MU-RTS 634.

The NAV 632 signaled in BA 630 is required to have a duration that at least ends equal to or later than the end of NAV of the CTS2self frame. Because the BA frame does not carry a BSSID field and does not have TA/RA equal to the BSSID, the PPDU carrying BA is classified as inter-BSS PPDU by STAx and STAx uses the NAV in BA frame to update its basic NAV.

After the first allocation, the AP continues the TXOP by sending another MU-RTS TXS 634 to STAx to allocate the second allocation. When STAx receives MU-RTS TXS for the second allocation, it cannot respond because the basic NAV indicates CCA busy.

To address the issue of wrongly updating the basic NAV of STAx, P2P data and BA frame between P2P STAs may be carried in a PPDU format that identifies the BSS of the AP, such as HE or EHT format, as in element 20 of Section 5.

To address the issue of wrongly updating the basic NAV of STAx, all the P2P frames, such as P2P data and BA frame between P2P STAs, may have a NAV which terminates at the end of the first allocation (P2P allocation), as in elements 21, 22, and 23 of Section 5.

To address the issue of wrongly updating the basic NAVs of STAx, the first MU-RTS TXS frame may have RA set to STA1's MAC address and TA set to BSSID. STAx upon receiving this frame identifies STA1 as an intra-BSS STA. Later, when it receives a BA addressed to STA1, it would only update the intra-BSS NAV as required.

To address the issue of wrongly updating the basic NAV of STAx, all the frames before or during the P2P exchange, may only set a NAV that must end earlier than the end of second MU-RTS frame. The second MU-RTS frame, or another frame sent by the AP before the second MU-RTS frame, may extend the NAV for the second allocation.

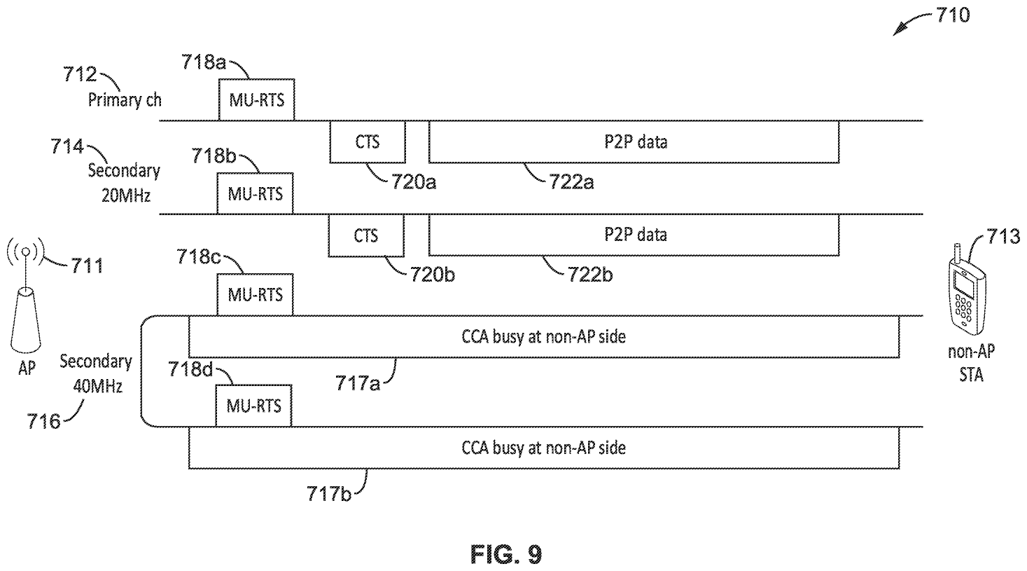

FIG. 9 illustrates an example embodiment 710 of an AP 711 transmitting MU-RTS 718a through 718d for assigning an allocation period with 80 MHz BW to the non-AP STA for P2P communication between non-AP STA and its P2P peer 713. In the figure is shown communications between AP 711 and non-AP STA 713 over a primary channel 712, a secondary 20 MHz channel 714, and a secondary 40 MHz channel 716 (depicted as comprising two 20 MHz channels).

The allocation duration may be based on the medium time in a Quality of Service (QoS) request previously signaled by a non-AP STA normalized to a 20 MHz bandwidth as in element 2 of Section 5. The AP may decide to allocate about one-fourth of the requested time for the communication medium, plus some overhead duration as an allocation duration for an 80 MHz bandwidth.

The non-AP STA detects secondary 40 MHz CCA busy 717a and 717b, (or P2P peer only supports 40 MHz), and only responds with CTS frames 720a and 720b on the primary 40 MHz channel, as described in element 3(a) of Section 5. It should be noted that the Primary 40 MHz channel is the primary 20 MHz channel+secondary 20 MHz by definition in the 802.11 specification.

The PPDU carrying the CTS frame, or the frame itself, may indicate the responding bandwidth/occupied channels as described in element 3(b) of Section 5, such as using the scrambler initiation or a control field in a control wrapper frame carrying the CTS frame. P2P Data 722a, 722b is transmitted over the Primary channel 712 and Secondary channel 714 from the non-AP STA 713 to AP 711.

The AP based on this bandwidth/occupied channel information, and based on normalized medium time in the QoS request received from the non-AP STA previously, determines additional subsequent P2P allocations to satisfy the QoS request. (not shown).

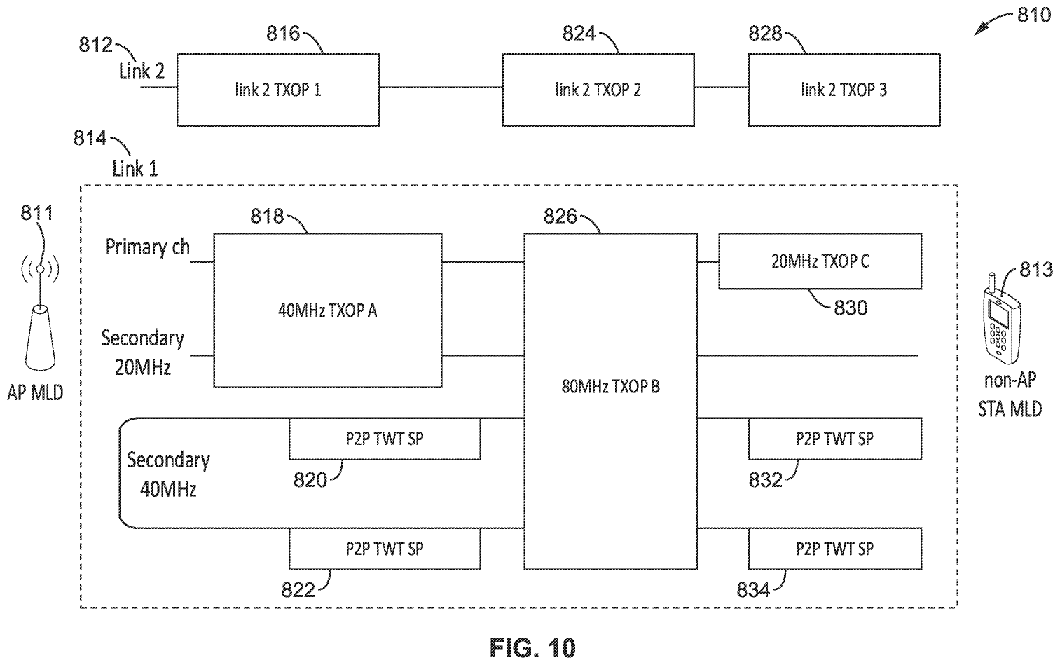

FIG. 10 illustrates an example embodiment 810 of a non-AP MLD 813 performing a P2P setup with a P2P peer on link 1 with a P2P TWT agreement.

The figure depicts a link2 812 with one or more channels; while link1 814 is shown with a Primary channel combined with a secondary 20 MHz channel, as well as another Secondary 40 MHz channel having two 20 MHz channels. Link1 814 and link2 812 are NSTR link pairs for the non-AP MLD 813.

The non-AP MLD 813 and its P2P peer uses TDLS off channel on the secondary 40 MHz channels of link 1. The non-AP MLD also has a setup link 2 that is NSTR paired with link 1. The non-AP STA signals its P2P TWT and the P2P channels to the associated AP MLD 811 are as described in element 7 of Section 5.

Based on the communicated setup information, the AP initiates communication with the non-AP MLD and other STAs, such as exemplified below.

Given the P2P TWT information, the AP avoids having 80 MHz TXOPs with the non-AP MLD, or other associated STAs, that overlaps with the P2P TWT SP. The AP MLD 811 does not communicate with the non-AP MLD 813 in the 40 MHz TXOP A 818 on link 1. The AP does not communicate with the non-AP MLD in the 20 MHz TXOP C 830 on link 1. The AP may communicate with the non-AP MLD in the 80 MHz TXOP B 826. The AP does not communicate with the non-AP MLD in link2 TXOP1 816. The AP does not communicate with the non-AP MLD in link2 TXOP3 828. The AP, may communicate with the non-AP MLD in link2 TXOP2 824.

The signaling of the P2P Target Wait Time (TWT) to the AP MLD, may be setup as a TWT with the AP. The TWT setup may include the identity of the P2P link and/or channels. The TWT can be performed as a broadcast TWT. The modification of the broadcast TWT by the AP MLD may implicitly modify the P2P TWT SP agreement between P2P STAs.

The AP may treat the non-AP STA of the non-AP MLD as in a dozing mode during the P2P TWT service period. The AP can utilize MU-RTS TXS to start P2P TWT SPs 820, 822, 832 and 834 in the off channel; toward avoiding medium synchronization (synch) delay of the P2P communication on the non-primary channel. For example, the AP may start an 80 MHz TXOP instead of 40 MHz TXOP A. Then before, or at the time, the P2P TWT SP starts, the AP sends MU-RTS to the non-AP MLD and possibly other STAs, and allocates the secondary 40 MHz to the non-AP MLD as P2P allocation.

The AP MLD may learn (obtain) P2P schedules from one of the P2P MLDx to schedule traffic to or from the AP to satisfy NSTR constraints of the MLD1. However, it may also need to learn (obtain) the identity of the other P2P MLDy communicating with the P2P MLDx, to schedule traffic to or from the AP to satisfy NSTR constraints of MLDy.

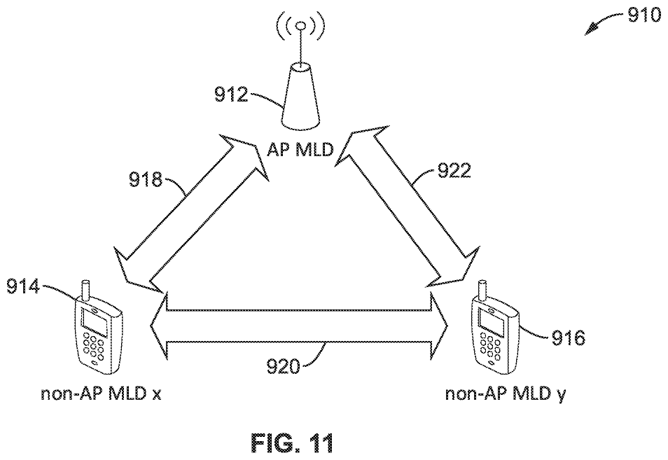

FIG. 11 illustrates an example embodiment 910 of a non-AP MLDx 914 setting up a P2P link with another non-AP MLDy 916 on one of their links, and both non-AP MLDs communicate with an AP MLD 912.

In step 918 the non-AP MLDx 914 sets up a Restricted-TWT (R-TWT) with AP MLD 912 on the P2P link. The R-TWT may be based on an existing TWT setup between the P2P STAs. The AP MLD may send MU-RTS transmission to MLDx to schedule P2P transmissions.

In step 920, the non-AP MLDx passes the R-TWT ID, to the peer non-AP MLDy as described in element 12 of Section 5.

The signaling may link the R-TWT ID with the P2P TWT ID. Both MLDx and MLDy should be in an awake state at the R-TWT on the P2P link.

In step 922, MLDy requests a setup to join a R-TWT with R-TWT ID with the AP on the P2P link as described in element 12 of Section 5, indicating its role as a P2P responder and does not require the scheduling of a MU-RTS transmission. From this setup information, the AP MLD knows (recognizes) is should not send traffic to MLDy on links that are NSTR paired with P2P link when the AP schedules MLDx for P2P transmission.

Alternatively, MLDx may provide the identity of MLDy to the AP MLD when setting up the R-TWT. The step 922 in this alternative may be optional as described in element 14 of Section 5.

MLDy may provide the identity of MLDx to the AP MLD. The AP MLD, recognizing the capabilities of both MLDs, may perform transmission or reception of other links to be consistent with the scheduling of the P2P allocation. The AP MLD may avoid starting a TXOP that overlaps with the P2P link R-TWT (or the actual allocation within the R-TWT) on links of either MLD that are NSTR paired with the P2P link.

The AP MLD may avoid starting a TXOP that overlaps with the P2P link R-TWT (or the actual allocation within the R-TWT) on other links that would result in the violation the maximum number of simultaneous links for either MLD. The MU-RTS transmission of the AP MLD may allocate a bandwidth that is consistent with the bandwidth capability of both MLDs on the P2P link.

4.2. Example Flowcharts

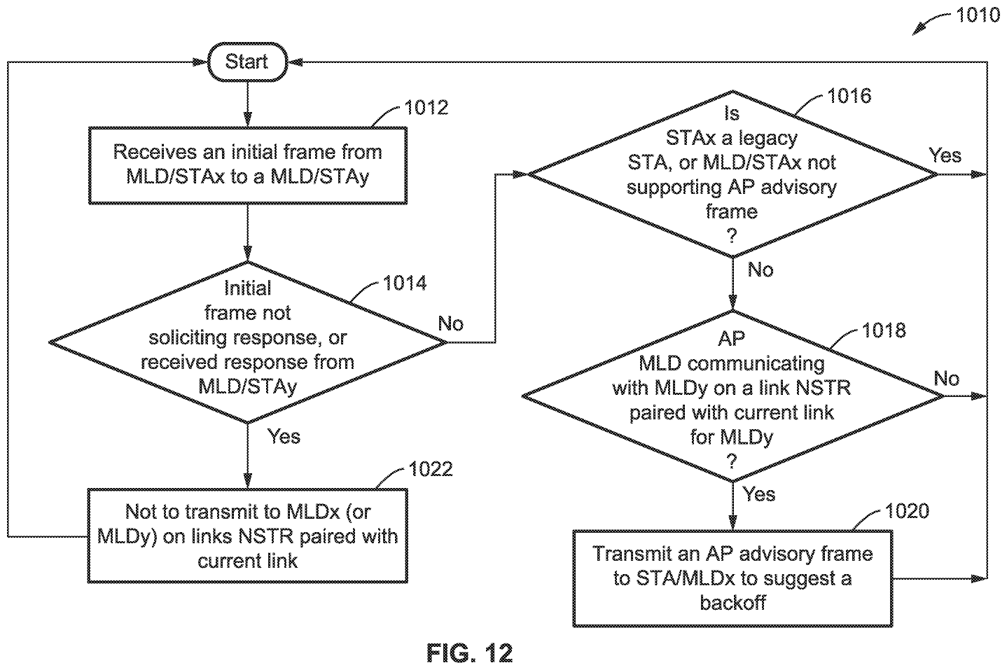

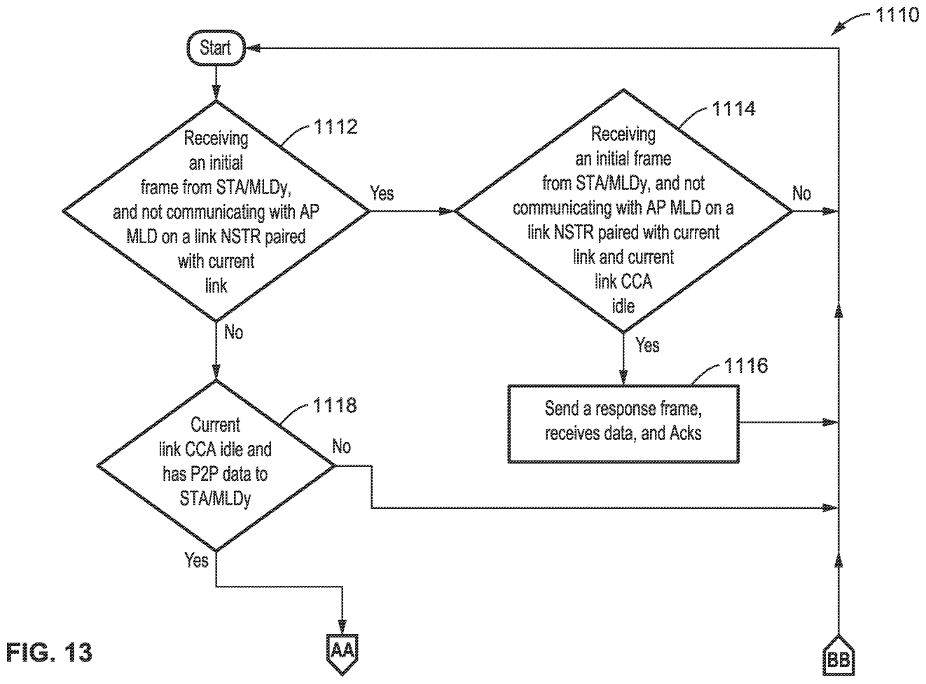

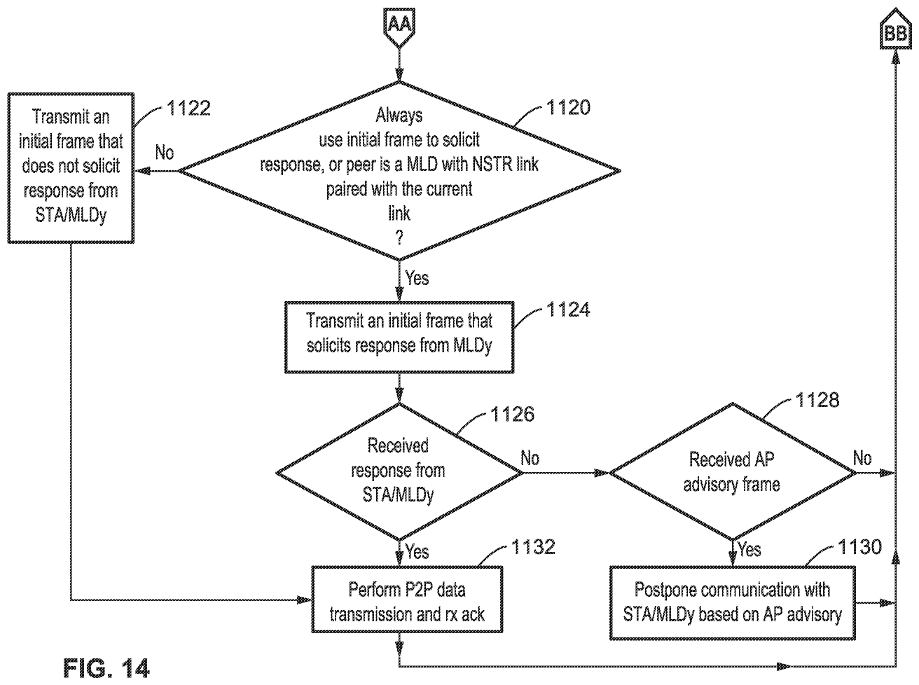

FIG. 12 through FIG. 14 describe the operations of the AP MLD (FIG. 12) and non-AP MLD (FIG. 13 and FIG. 14) in performing the actions described in elements 5, 6 and 8 of Section 5, and as seen in FIG. 3 and FIG. 4.

In FIG. 12 the example embodiment 1010 depicts the AP receiving 1012 an initial frame from an MLD or STAx to a MLD or STAy. Check 1014 determines if the initial frame is either not soliciting (requesting) a response, or has received a response, from the MLD/STAy. If either condition is met, then at block 1022 the AP decides not to transmit to MLDx (or MLDy) on links which are NSTR paired with the current link, with a return to the start of the process.

If the condition of check 1014 is not met, then check 1016 determines if STAx is a legacy STA, or otherwise the MLD/STAx is does not support the use of an AP advisory frame. If the condition is met, and the STA/MLD do not support the advisory frame, then execution returns to the start of the process.

Otherwise, at check 1018 it is determined if the AP MLD is communicating with MLDy on a link which is NSTR paired with a current link for MLDy. If the condition is not met, then execution returns to the start of the process. Otherwise, at block 1020, the AP transmits an AP advisory frame to the STA or MLDx to suggest a backoff, after which execution returns to the start of the process.

The following now describes the counterpart of the above process as performed on the side of the non-AP MLD.

In FIG. 13 the example embodiment 1110 starts with check 1112 to determine if the non-AP is not receiving an initial frame from a STA or MLDy, and not communicating with the AP MLD on a link which is NSTR paired with the current link.

If the condition is met, then block 1114 performs a check to determine if: (1) it is receiving an initial frame from STA or MLDy, (2) not communicating with the AP MLD on a link which is NSTR paired with the current link, and (3) the current link is CCA idle before or after the received initial frame. If the condition is not met, then execution returns to the start. Otherwise, block 1116 sends a response frame, receives data, and acknowledges the data before execution returns to the start.

Returning now to consider the case of the condition not being met at check 1112, in which case block 1118 performs a check whether the current link is Clear Channel Assessment (CCA) idle and there is P2P data to be sent to the STA or MLDy.

If the condition is not met, then execution returns to the start. Otherwise, execution moves to block 1120 in FIG. 14 which checks if it should always use the initial frame to solicit a response, or optionally check its Peer on MLDy (with NSTR link paired with the current link).

If condition 1120 is not met then at block 1122 the non-AP MLD transmits an initial frame that does not solicit a response from the STA or MLDy, with execution moving on to block 1132 which performs a P2P data transmission and receives an Ack, before execution returns to the start of the process.

If condition 1120 is met, then at block 1124 the non-AP MLD transmits an initial frame that solicits a response from MLDy. Then at check 1126 it is determined if the non-AP MLD has received a response from MLDy. If it has received a response, then at block 1132 the non-AP MLD performs a P2P data transmission and receives an Ack, before execution returns to the start of the process.

Otherwise, with the condition of check 1126 not being met, then check 1128 determines if the AP has received an advisory frame. If the condition is not met, then execution returns to the start of the process. If check 1128 is met, then at block 1130 the non-AP MLD postpones communication with the STA or MLDy based on the AP advisory, and execution returns to the start of the process.

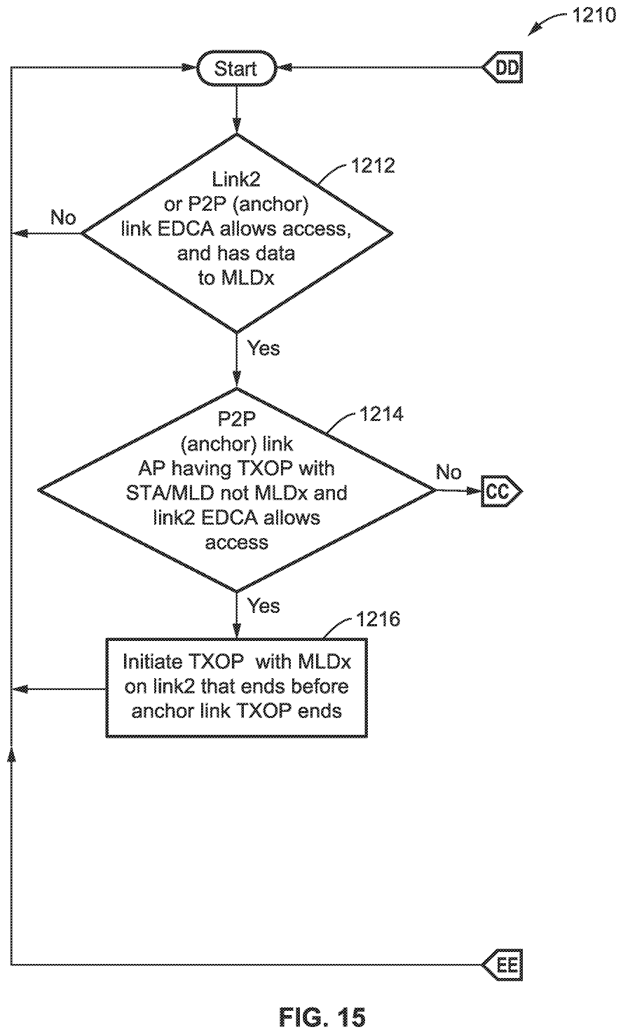

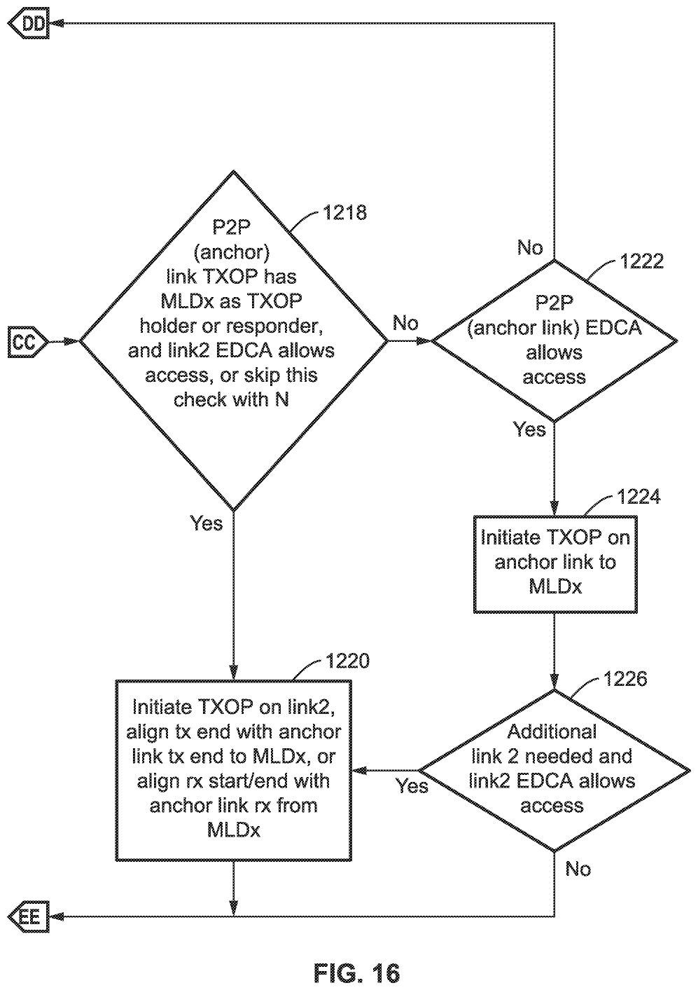

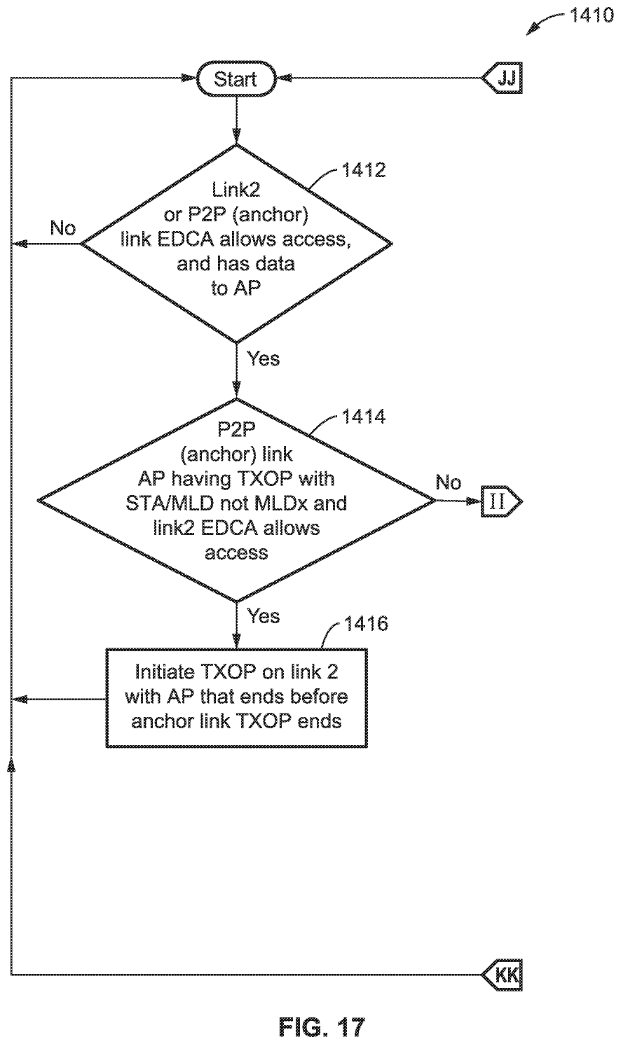

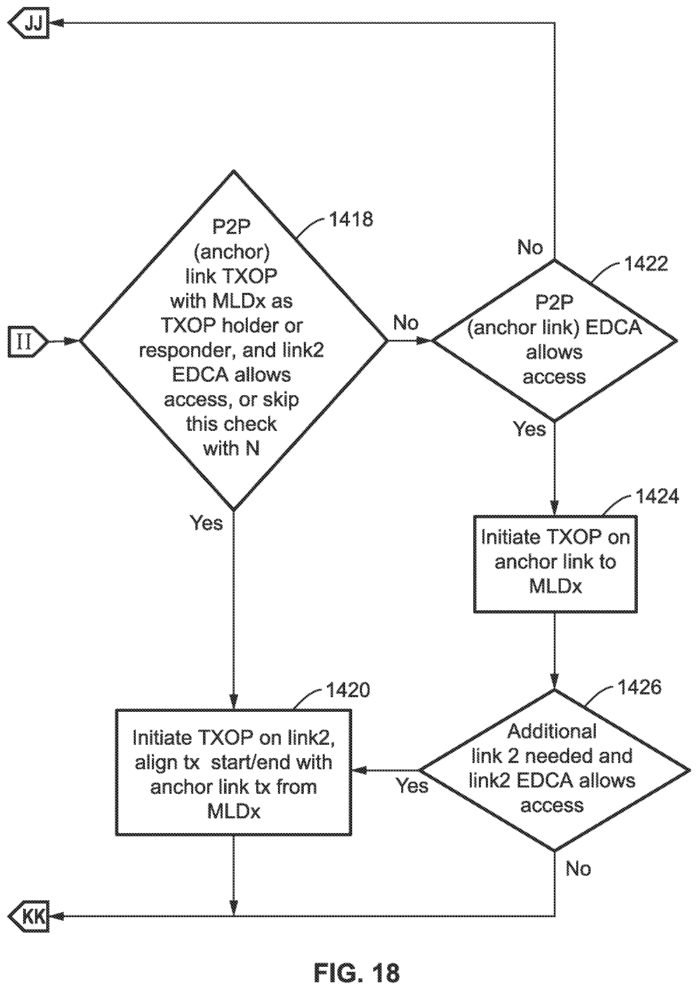

FIG. 15 through FIG. 18 describe the operations of the AP (FIG. 15 and FIG. 16) and the non-AP MLD (FIG. 17 and FIG. 18) as described in element 9 and 10 of Section 5, and as shown in FIG. 6 and FIG. 7.

In FIG. 15 the example embodiment 1210 starts with the AP MLD checking 1212 if link2, or the P2P (anchor) link allows EDCA access, and has data to transmit to MLDx. If the condition is not met, then execution returns to the start of the process.

Otherwise, with the 1212 condition being met, check 1214 determines if the P2P (anchor) link of the AP has a TXOP with a STA or MLD which is not MLDx, and that link allows EDCA access. If condition 1214 is met, then at block 1216 the AP initiates a TXOP with MLDx on link2 that ends before the anchor link TXOP ends, and execution returns to the start of the process.

Otherwise, if condition at check 1214 is not met, then execution moves to block 1218 in FIG. 16 which checks if the P2P (anchor) link TXOP has MLDx as TXOP holder or responder, and if link2 EDCA access is allowed, or if this check with simultaneous links N should be skipped. If the condition is met, then execution reaches block 1220, which is described later.

If the condition is not met, then check 1222 determines if the P2P (anchor) link allows EDCA access. If the condition is not met, execution returns to the start of the process. Otherwise, at check 1224 the AP initiates a TXOP on the anchor to the MLDx, and check 1226 determines if an additional link2 is needed, and if link2 allows EDCA access. If these conditions are not met, then execution returns to the start of the process.

Otherwise, if condition 1226 is met, then execution reaches block 1220 in which the AP MLD initiates a TXOP on link2, aligning the end of the transmission with the end of the transmission to MLDx, or aligning both the start and the end of the transmission with the anchor link received from MLDx. After which execution returns to the start of the process.

In FIG. 17 and FIG. 18 the example embodiment 1410 show the counterpart processing of the above for the non-AP MLD. Execution starts and at block 1412 with the non-AP checking on whether link2 or the P2P (anchor) link allows EDCA access, and also have data to send to the AP. If the condition is not met, then execution returns to the start of processing.

Otherwise, with the condition being met, check 1414 determines if the P2P (anchor) link AP having a TXOP with STA or MLD, and not the MLDx, and link2 allows EDCA access. If the condition is met, then at block 1416 the non-AP MLD initiates a TXOP on link2 with an AP that ends before the anchor link TXOP expires, and then execution returns to the start of processing.

If the condition at check 1414 is not met, then execution moves to block 1418 in FIG. 18 with the non-AP MLD determining if the P2P (anchor) link TXOP is with MLDx as TXOP holder or responder, and if link2 allows EDCA access, or if this check should be skipped with simultaneous links N. If the condition is met, then at block 1420 the non-AP MLD initiates a TXOP on link2 and aligns the start and or end of the transmission with the anchor link transmission from MLDx, then execution returns to the start of processing.

Otherwise, if the condition is not met, then check 1422 determines if the P2P (anchor link) allows EDCA access. If the condition is not met, then execution returns to the start of processing. Otherwise, the non-AP MLD initiates 1424 a TXOP on the anchor link to MLDx. Check 1426 then determines if an additional link2 is needed, and if link2 allows EDCA access. If the condition is not met, then execution returns to the start of processing. If the condition is met, then execution reaches block 1420, which was described above.

4.3. Example Frames and Fields

4.3.1. AP Advisory Frame

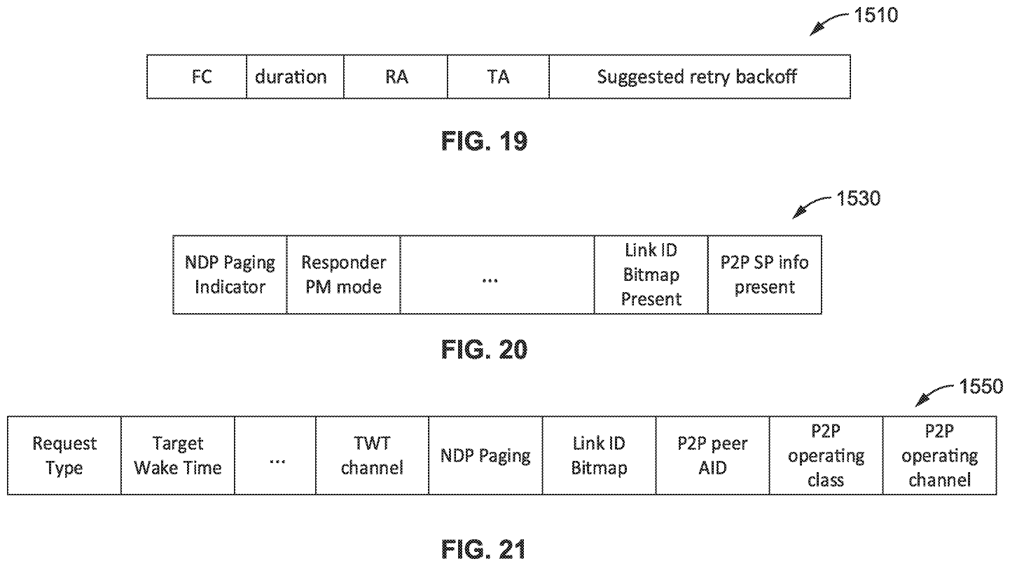

FIG. 19 illustrates an example embodiment 1510 of a frame format for the AP Advisory frame as described in element 8 of Section 5, and the new Delay-To-Send (DTS) frame as seen in FIG. 4 and FIG. 5. The frame is shown with a Frame Control (FC) field defining the type of field and some control information. The other fields include Receiver Address (RA), Transmitter Address (TA), and a Suggested Retry Back field.

The Suggested Retry Backoff field indicates the duration in time units that the AP suggests for initiating P2P STA not to contact P2P peer due to constraints, such as a link NSTR paired with P2P link is in active communication between AP and P2P peer, or that the number of simultaneous links in communication between the AP and P2P peer is at its maximum allowed value before the end of the duration.

4.3.2. P2P TWT Information Using Individual TWT Signaling

FIG. 20 illustrates an example embodiment 1530 of a control field in a TWT element that can be used for the signaling described in element 7 of Section 5, and the example associated with FIG. 10 if the off-channel P2P SP information is signaled using an individual TWT request. The fields are depicted as an NDP Paging indicator, a Responder PM mode field, some other fields, a Link ID Bitmap Present field, and a P2P SP Information present field which indicates the presence of the last three fields in FIG. 21.

FIG. 21 illustrates an example embodiment 1550 of an Individual TWT parameter set field with the additional last three fields of P2P Peer AID (i.e., P2P using TDLS), P2P Operating Class, and P2P Operating Channel which identifies the P2P channel used for the P2P communication. These last three fields may only be present if a TWT command is requested, suggested or demanded.

The P2P TWT is conveyed in the Target Wake Time and Nominal Minimum TWT Wake duration, TWT interval Mantissa, TWT wake Interval Exponent fields (existing fields).

4.3.3. P2P TWT Information Using Broadcast TWT Signaling

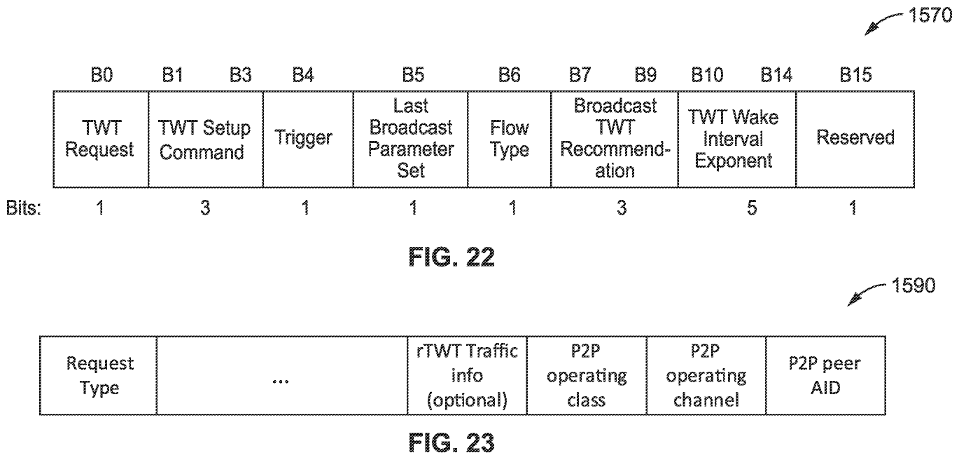

FIG. 22 illustrates an example embodiment 1570 of a Request Type field in a Broadcast TWT Parameter Set field in a TWT element, that can be used for signaling as described in elements 7, 12, 14 in Section 5, and the example associated with FIG. 10, and in FIG. 11 steps 918 and 922.

The request field is shown with the following subfields: TWT Request, TWT Setup Command, Trigger, Last Broadcast Parameter Set, Flow Type, Broadcast TWT Recommendation, TWT Wake Interval Exponent, with the remaining bit shown as Reserved.

The Broadcast TWT Recommendation may be set to a value x to indicate setting up a P2P R-TWT that requires MU-RTS transmission scheduling. The value may also indicate the presence of the last three fields in FIG. 23.

The Broadcast TWT Recommendation may be set to a value y to indicate setting up a P2P R-TWT that does not require MU-RTS transmission scheduling. The value may also indicate the presence of the last three fields in FIG. 23.

FIG. 23 illustrates an example embodiment 1590 of a Broadcast TWT Parameter used for a R-TWT request as described in elements 12 and 14, and exemplified in FIG. 11 steps 918 and 922. The P2P operating class and channel identifies a P2P channel. The P2P peer AID identifies the peer STA to the AP. The P2P TWT is conveyed in the Target Wake Time and Nominal Minimum TWT Wake duration, TWT interval Mantissa, TWT wake Interval Exponent fields (existing fields). When the broadcast TWT element is sent in broadcast, the last three fields may not be present.

5. Embodiment Description Outline

The following describes important elements of the present disclosure in a hierarchical outline format, including references between elements, so that the interoperation of these aspects can be described.

1. A MLD which reserves channel time to AP MLD may not be aware of the channel width that will be allocated by AP MLD for P2P communication. (a) In at least one embodiment, the P2P BW/TXOP may be allocated by AP using MU-RTS TXS trigger frame.

2. The MLD, when sending its QoS request to the AP MLD for P2P channel time, may normalize the requested time based on a fixed bandwidth on a link;

(a) For example, the actual channel time may be halved if the AP is allocating twice the bandwidth than the fixed bandwidth.

3. The AP learn the actual usable BW for P2P TXOP allocated by the MU-RTS TXS trigger frame:

(a) In at least one embodiment, the frame responding to the MU-RTS TXS trigger frame may occupy a fraction of the bandwidth assigned by MU-RTS TXS; The responding frame may be required to occupy the primary channel;

(b) In at least one embodiment, the frame responding to the MU-RTS TXS trigger frame may carry Bandwidth information. (b)(i) For example, the bandwidth information may be encoded in the scrambling seed of the CTS frame, for example the CTS frame responding to MU-RTS may not use the same scrambling seed as the MU-RTS frame; and because there is only one responder to the MU-RTS TXS frame, the CTS frame would still be decodable; and (b)(ii) The responder of an MU-RTS TXS may respond with a CTS frame on the allocated sub-channels that are considered to be CCA idle, even if the responding bandwidth is smaller than the MU-RTS frame allocated bandwidth; (b)(iii) The responder of MU-RTS TXS may respond with a CTS frame only on sub-channels that are supported by P2P peer; and

(c) The AP may utilize learned bandwidth as a basis for adjusting additional allocated time for the P2P communication.

4A. The AP may indicate in MU-RTS TXS frame, or in an earlier frame, that the mechanism of element 3 is allowed, in which the AP learns the actual usable BW for P2P TXOP allocated by the MU-RTS TXS trigger frame.

Otherwise, the receiver of the MU-RTS must respond on the same sub-channel(s) allocated by or occupied by the MU-RTS TXS frame, or not respond at all.

4B. A non-AP MLD with a (potential) off-channel TDLS/P2P channel setup can signal the AP MLD whether the TDLS/P2P channel and the current setup links with the associated AP MLD are NSTR link pairs.

5. A non-AP MLD with NSTR links pairs in some cases may be required to perform an initial frame transmission before the P2P communication takes place on one of the links which have been setup with the associated AP MLD so that the non-AP MLD can indicate its identity.

(a) For example, a TDLS data PPDU1 TDLS which is a DL PPDU (DL flag=1) and is used to start a P2P TXOP. The preamble of PPDU1 does not carry the identity of the initiator MLD X. The AP is not aware that the identity of the initiator being MLD X, and the AP may transmit another PPDU2 on a link which is NSTR to the TDLS link to the MLD X. Thus, the PPDU2 may be lost due to self-interference at MLDx.

(b) The frame may (implicitly) indicate identity of the initiator non-AP MLD and the P2P TXOP responder's identity. For example, the TA and RA of a RTS frame as the frame to setup the P2P TXOP. The AP MLD, which learns the MLDs associated with the TA/RA having NSTR link pairs with the current link, may pause sending the PPDU(s) to the MLDs on the NSTR link.

(c) The P2P peer may be within the coverage area of the AP MLD on the P2P link;

(d) The non-AP MLD and/or P2P peer may be required to signal the link ID of the P2P link to the AP MLD;

(e) The P2P peer may not respond to the initial frame if it has ongoing communication with AP MLD on non-P2P links, which are NSTR paired with the P2P link; (e)(i) The P2P peer may respond with a frame advising a backoff on the P2P link, similar to the description element 8 (in which the AP MLD may send a responding (AP advisory) frame responding to the initial frame), if the P2P peer is transmitting on the non-P2P link;

(f) If the non-AP MLD and the peer MLD shares the same non-P2P link with the AP MLD, then the non-AP MLD may autonomously enter a backoff on the P2P link without sending an initial frame if it has detected an ongoing TXOP between the AP MLD and the peer MLD on the non-P2P link, and (P2P link, non-P2P link) is a NSTR link pair for the peer MLD; (f)(i) The non-AP MLD may also send the P2P PPDU that is end aligned with the PPDU from the AP to the P2P peer assuming that the immediate response on P2P link does not affect the communication for the P2P peer on the non-P2P link; and

(g) If the P2P peer MLD does not have NSTR link pair, or P2P peer is a single link device, the initial frame may not solicit a responding frame before the data transmission of the non-AP MLD.

6. A non-AP STA or MLD with no NSTR links pairs with the P2P link may be required to perform an initial frame transmission before the P2P communication:

(a) If the potential P2P responder is an MLD, which has an NSTR link pair with P2P channel/link, and the P2P responder are exchanging frames with the AP MLD on a link which is a NSTR link pair to the P2P channel/link and is not able to perform a P2P communication, then the P2P TXOP initiator may perform a backoff after not receiving a responding frame from the P2P responder;

(b) The AP on the P2P channel may require a legacy non-AP P2P initiator to utilize a Ready-To-Send/Clear-To-Send (RTS/CTS) mechanism on the P2P channel by indicating a small value in the TXOP Duration RTS Threshold subfield in the HE Operation Parameters field in the HE Operation element sent by the AP;

(c) The P2P peer should be within the coverage area of the AP MLD on the P2P link;

(d) The non-AP MLD and/or P2P peer may be required to signal the link ID of the P2P link to the AP MLD;

(e) The P2P peer may not respond to the initial frame if it has ongoing communication with the AP MLD on non-P2P links which are NSTR paired with the P2P link; and

(f) If the non-AP MLD and the peer MLD shares a same non-P2P link with the AP MLD, then the non-AP MLD may autonomously enter into a backoff on the P2P link, without sending the initial frame, if it has detected an ongoing TXOP between the AP MLD and the peer MLD on the non-P2P link, and (e.g., P2P link, non-P2P link) is a NSTR link pair for the peer MLD.

7. A non-AP MLD with NSTR links pairs may be required to signal the AP MLD its service period(s) (SPs) with a P2P peer that is setup transparently to the AP MLD:

(a) For example, the service periods may be P2P TWT SPs setup with a TDLS peer on a link which has NSTR link pairs for the MLD;

(b) In at least one embodiment, this requirement is only in effect if the P2P channel does not overlap with the (primary) channels of any of the setup links with the AP MLD: (b)(i) The non-AP may also signal the channel(s) and link used for the P2P SP; (b)(ii) The AP may use this information to avoid TXOP with the non-AP MLD on links that are NSTR paired with the channels used in P2P link, overlapping with the P2P SP; (b)(iii) The AP may use this information to avoid TXOP with the non-AP MLD on P2P link occupying the P2P channels, overlapping with the P2P SP; and (b)(iv) For example if AP monitors the P2P channel, instead of using the mechanism in element 7, the AP MLD may use the mechanism in element 5 to determine the start of the P2P service period on a channel AP MLD monitors without the knowledge of the P2P service period.

8. For the mechanism in elements 5 (in which a non-AP MLD with NSTR links pairs may be required to perform an initial frame transmission before the P2P communication takes place on one of the links which have been setup with the associated AP MLD to indicate its identity) and element 6 (in which a non-AP STA or MLD with no NSTR links pairs with the P2P link may be required to perform an initial frame transmission before the P2P communication), then if the AP MLD is engaging in communication on a link that is NSTR pair with the P2P channel with the P2P responder, the AP MLD may send a responding (AP advisory) frame responding to the initial frame:

(a) The responding frame may indicate a suggested backoff on the P2P channel before retry; The suggested backoff may be based on the remaining TXOP on the NSTR link in which AP exchanges frames with the P2P responder;

(b) The suggested backoff may be a communicated in a different field than the duration field, while the duration field may indicate a 0 NAV value; and

(c) The Inter-Frame Spacing (IFS) between the initial frame and the responding frame from AP may be larger than the IFS interval between the initial frame and a responding frame from the P2P responder, such that the AP MLD can confirm that the P2P responder is not responding due to activities on other links. Alternatively, the IFS may comprise a Short IFS (SIFS).

9. A non-AP MLDx with NSTR link pair(s) with a P2P link, and the P2P link is one of the setup links with the associated AP MLD, may request to the AP MLD the P2P link as an anchor link:

(a) Any time a PPDU is sent between (MLDx, AP MLD) on any link NSTR paired with the anchor link, there should be another PPDU on the anchor link from the MLDx or AP, for example the P2P peer is CCA busy on the anchor link;

(b) The P2P peer should be in the coverage area of the AP MLD on the P2P link;

(c) If PPDUs on both links (the P2P link and a link y that is NSTR paired with the P2P link) are sent to the MLDx, then the end time of each of these PPDUs should be approximately aligned;

(d) If PPDUs on both links (the P2P link and a link y that is NSTR paired with the P2P link) are from the MLDx; then the start and end times of the PPDUs should be approximately aligned; and

(e) For element 9(c), 9(d) above, the soliciting PPDU (e.g., its contents) should not cause the responding PPDU to violate element 9(a).

10. The overlapping time requirement between two PPDUs in element 9 may alternatively be replaced by TXOPs:

(a) Any time there is a TXOP between (MLDx, AP MLD) on any link NSTR paired with the anchor link, there should be another TXOP on the anchor link in which either initiator or responder is a MLDx, or in which either initiator or responder is an AP, for example the P2P peer is CCA busy on the anchor link;

(b) Element 10 (a) can be further restricted to: Any time there is a TXOP between (MLDx, AP MLD) on any link NSTR paired with the anchor link, there should be another TXOP on the anchor link in which either the initiator (or responder) is a MLDx, or in which initiator (or responder) is the AP;

(c) Elements 9(a), 9(b), 9(c), 9(d) requirements may apply;

(d) If the AP is not in a TXOP on the anchor link, then the AP MLD may simplify the procedure further by not transmitting a PPDU to the MLDx on a link which is NSTR paired with anchor link;

(e) An AP MLD may simplify the procedure further by not transmitting a PPDU to the MLDx on a link which is NSTR paired with the anchor link, if the AP is not a TXOP holder on the anchor link; and

(f) For elements 10(d) and 10(e) above, the AP MLD is not required to recognize the identity of the sender or receiver of the P2P PPDU on the anchor link for preventing interference between (MLDx, AP MLD) communication on non-anchor link and MLDx's P2P communication on anchor link.

11. A P2P STAx (or MLDx) may request to setup a P2P R-TWT on a link L1, and the following considerations arise when this request is granted by the AP affiliated with an AP MLD; The AP may send MU-RTS TXS frame on link L1 within the R-TWT SP with an allocation for P2P SP; The AP may not be aware of the identity of peer STAy of the STAx for the allocation; In the case that the peer STAy is affiliated with a MLDy which is associated with the AP MLD, during the allocation, the AP MLD may send frames to MLDy on a link L2 which is NSTR paired with link L1; The link L1 (STAx, STAy) communication may interfere with link 2 (AP, MLDy) communication.

12. To avoid the issue in element 11, the STA/MLDx may provide the R-TWT ID which is used for P2P communication with the STAy/MLDy to the STAy/MLDy through using the P2P communication; After acquiring this information, STAy/MLDy may setup to join the R-TWT with the informed R-TWT ID, indicating its role as a P2P TXOP responder and does not require MU-RTS TXS to be scheduled; The STAy/MLDy may also provide the identity of the STAx/MLDx to the AP;

(a) STAy would be in the awake state during the SP of the R-TWT before P2P communication finishes within the allocation, but does not require scheduling from the AP.

13. Based on the mechanism in element 12, the AP MLD recognizes when it is not to initiate communication on link L2 to MLDy during the allocation duration assigned by MU-RTS TXS sent on link L1.

14. The mechanism in element 12 can be replaced by STAx/MLDx signaling the identity of STAy/MLDy in its R-TWT request in element 11, in order for AP MLD not to initiate communication on link L2 to MLDy during the allocation duration assigned by MU-RTS TXS sent on link L1;

(a) The STAx/MLDx may still need to provide the R-TWT ID to STAy/MLDy, such that the STAy/MLDy would be in an awake state on the P2P link during the R-TWT.

15. Mechanisms described in element 5 through 14 element may not only be applied to the cases that a MLD having P2P link that is NSTR paired with another link, but It may also be applicable to a MLD with STR links paired with the P2P link, such that the AP MLD would not initiate communication with the MLD exceeding the capability of the maximum number of simultaneous links for the MLD;

(a) For example, in element 5, the maximum number of simultaneous links=N for MLDx. Upon receiving the initial frame and/or its response frame for initiating a P2P TXOP on link L1, the AP MLD may at most initiate transmission on N−1 links that are STR paired with the link L1; and

(b) For example, in element 10, when an anchor link is CCA busy, then based on element 10(d) and 10(e) the AP MLD may at most initiate transmissions on N−1 links that are STR paired with the anchor link to guarantee that the maximum number of simultaneous links=N is not violated for MLDx.

16. Mechanisms described in elements 5 through 8, 11 through 14 may not only be applied to the cases that a MLD having P2P link that is NSTR paired with another link, but it may be also applicable to an Enhanced Multilink Single-Radio (EMLSR) non-AP MLD with links sharing radio resources with the P2P link, such that the AP MLD would not initiate communication with the MLD on non-P2P links while the MLD is communicating with its P2P peer using the radio resources that are otherwise used by other link(s);

(a) For example, the initial frame in element 5 may be used to inform the peer MLD to switch radio resources to the P2P link, and/or to inform the AP MLD not to initiate communications with either the P2P initiator or the P2P responder that is an EMLSR MLD; The initial frame may allow padding to accommodate the switching time of radio resources;

(b) For example, during the R-TWT SP in elements 11 through 14, MLDx or MLDy may switch the radio resources to the P2P link; The AP MLD may not initiate communications on other links to either the P2P initiator or the P2P responder during the P2P allocation duration; and

(c) For example, during the P2P SP in element 7, the non-AP MLD may switch the radio resources to the P2P link; and the AP MLD may not initiate communications to either P2P initiator or P2P responder MLD on other links.

17. An AP using multiple frame protection may acquire a TXOP, and performs multiple allocations in the TXOP, with a non-last allocation being a P2P allocation:

(a) The NAV which is set within frames of these allocation is required to have a NAV end time which extends beyond or equal to the end time of the TXOP initially acquired by the AP based on the rules currently defined in 802.11 rev. and D1.0 9.2.5.2; and

(b) The allocations can be trigger based UpLink (UL) Multi-User (MU) access or MU-RTS TXS based UL/P2P access.

18. For the allocation using MU-RTS TXS based P2P access, there can be frames sent in pre-HE format (such as control frames in non-HT format) that do not carry a Basic Service Set Identification (BSSID) in its address fields; These frames have TA/RA set as the MAC addresses of two P2P STAs; These frames may carry a NAV with an end time beyond the allocation end time; These frames may set basic NAV of intra-BSS STAs.

19. When the AP sends a trigger frame or MU-RTS TXS frame in the next allocation within the same TXOP for MU/SU scheduling, then if the addressed STA previously received the frames described in element 18, it does not respond to the trigger so as not to interfere with a perceived OBSS TXOP because the basic NAV does not indicate that the medium is idle.

20. For resolving the issue in element 19, a PPDU carrying frames in a P2P allocation, may be required to be in a PPDU format that can identify its BSS, such as in HE or EHT format.

21. For resolving the issue in element 19, a PPDU carrying frames in an allocation without BSSID/AP MLD address in its address fields, may be required to set NAV (in the preamble or frames within the PPDU) with an end time which does not extend beyond the end of the current allocation duration.

22. For resolving the issue in element 19, a PPDU carrying frames in an allocation that may solicit a responding PPDU which carries a frame without BSSID/AP MLD address in its address fields, may be required to set NAV (in the preamble or frames within the PPDU) with an end time not greater than the end of the current allocation duration.

23. For resolving the issue in element 19, all frames in an allocation duration may be required to set NAV with an end time that does not extend beyond the end of the current allocation duration.

24. For resolving the issue in element 19, the MU-RTS TXS frame may have a RA set to a unicast MAC address of a STAx. The other STAs in the BSS can determine that STAx is an intra-BSS STA, based on the RA and TA (BSSID) values in the frame. Later in the allocation duration, frames exchanged between STAx and P2P peer STAy, other intra-BSS STAs would set intra-BSS NAV based on STAx's MAC address in the address fields in the frames; The intra-BSS NAV would not prevent these intra-BSS STAs from responding to subsequent trigger frames.

25. For resolving the issue in element 19, the frame used for allocating P2P SP, such as MU-RTS TXS, has a NAV end time which does not extend beyond the end of the allocation duration plus some margin; The AP may, at the end of the allocation duration, transmit another frame to extend the TXOP.

26. The mechanism described in element 9 may involve sending a PPDU on each link which belongs to a NSTR link pair for the receiver.

27. When receiving on two links that are a NSTR pair for a receiver MLD:

(a) The receiver on an anchor link may use the activity on an anchor link to wake up the receiver on the non-anchor link; (i) The activity on the anchor link may be the reception of a preamble, or reception of a frame;

(b) For example, the AP MLD and NSTR non-AP MLD may agree to maintain an anchor link in an awake state for the non-AP: (b)(i) the AP may use an initiation frame (which may solicit a responding frame) on an anchor link to indicate that the non-AP should transmit so that the non-anchor link enters an awake state, then the AP may start transmitting DL PPDUs on both links after the initial exchange. The DL PPDU on the non-anchor link may be end-aligned with, but may start later or at the same time, as the PPDU on the anchor link; (b)(ii) the AP may use a preamble of a PPDU on the anchor link to indicate that the non-AP should transmit so that the non-anchor link enters an awake state, then the AP may start transmitting a DL PPDU on the non-anchor link after a preamble (predefined) duration. The PPDU on the non-anchor link is end-aligned with the PPDU on the anchor link, but the PPDU may start later than the PPDU on the anchor link;

(c) For example, the AP MLD is a mobile NSTR MLD, and the AP is normally in a dozing (sleep) state on the an-anchor/non-primary link when both links are idle; (c)(i) A STA1 on primary link may transmit a PPDU to the AP MLD on anchor/primary link; The detection of the preamble on the primary link causes the AP MLD to exit the dozing (sleep) state on the non-primary link; Another STA2 then may start transmitting another PPDU on the non-primary/non-anchor link end-aligned with the PPDU on the anchor link; The STA1 and STA2 may belong to the same MLD or belong to different devices not in the same MLD; (c)(ii) A STA1 on the primary link may transmit a frame to the AP MLD on anchor/primary link. The detection of the frame on the primary link causes the AP MLD to exit the dozing state on the non-primary link; The frame may solicit a response from the AP on the primary link; Another STA2 may then start transmitting another PPDU on non-primary/non-anchor link end-aligned with the PPDU on the anchor link (possibly also with start alignment with PPDU on the anchor link); STA1 and STA2 may belong to the same MLD or belong to different devices not in the same MLD.

(d) In the mechanisms in elements 27(b)(ii) and 27(c)(i), the receiver MLD may return to dozing state on the non-anchor/primary link after a duration if it has not received a start of a PPDU on the non-anchor/primary link. The duration may be known to the receiver MLD and the possible transmitters on the non-primary link;

(e) In the mechanisms in elements 27(b) and 27(c), the receiver MLD and possible transmitters on the non-anchor/primary link may agree that during one or more designated PPDUs in a TXOP on the primary link, the transmitters may not transmit PPDUs on the non-primary/non-anchor link that overlap with the duration of those designated PPDUs on the primary link; (e)(i) The receiver on the non-primary/non-anchor link may use the duration of the these designated PPDUs to doze (sleep) or transition to/from the awake state; (e)(ii) For example, the designated PPDUs may be the first (N) PPDUs in the TXOP on the primary/anchor link;

(f) In the mechanism in elements 27(a)(i) and 27(c)(ii), a transmitter that transmits an initial frame on the non-primary/non-anchor link at the same time as the initial frame on the primary/anchor link, but does not get a response to the initial frame on the non-primary/non-anchor link, yet which observed the response to an initial frame on the primary/anchor link, may not need to perform the backoff procedure (on the non-primary/non-anchor link caused by the lack of response on the non-primary/non-anchor link) if CCA still indicates idle on the non-primary/non-anchor link.

6. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for wireless communication in a network, the apparatus comprising: (a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links; (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol in which the STA operating as an AP using multiple frame protection acquire a TXOP, and performs multiple allocations in the TXOP, comprising: (d)(i) setting a NAV within frames of allocation required to have a NAV end time which extends beyond the end time of the TXOP initially acquired by the AP; and (d)(ii) wherein said allocation can be trigger based UpLink (UL) Multi-User (MU) access or MU-RTS TXS based UL Peer-To-Peer (P2P) access.

An apparatus for wireless communication in a network, the apparatus comprising: (a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links; (b) a processor coupled to said wireless communication circuit for operating on the WLAN; (c) a non-transitory memory storing instructions executable by the processor for communicating with other STAs; and (d) wherein said instructions, when executed by the processor, perform steps of a wireless communications protocol in which the STA operating as an AP using multiple frame protection acquire a TXOP, and performs multiple allocations in the TXOP, comprising: (d)(i) setting a NAV within frames of allocation required to have a NAV end time which extends beyond the end time of the TXOP initially acquired by the AP; and (d)(ii) wherein said allocation can be trigger based UpLink (UL) Multi-User (MU) access or MU-RTS TXS based UL Peer-To-Peer (P2P) access; and (d)(iii) wherein said allocation is using a MU-RTS TXS based P2P access, in which frames are sent in a pre-HE format that do not carry a Basic Service Set Identification (BSSID) in its address fields.

A method of performing wireless communication in a network, comprising: (a) performing wireless communication of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links, and in which the STA operating as an AP using multiple frame protection acquire a TXOP, and performs multiple allocations in the TXOP; (b) setting a NAV within frames of allocation required to have a NAV end time which extends beyond the end time of the TXOP initially acquired by the AP; and (c) wherein said allocation can be trigger based UpLink (UL) Multi-User (MU) access or MU-RTS TXS based UL Peer-To-Peer (P2P) access.

The apparatus or method of any preceding or following implementation, wherein said allocation is using a MU-RTS TXS based P2P access, in which frames are sent in a pre-HE format that do not carry a Basic Service Set Identification (BSSID) in its address fields.

The apparatus or method of any preceding or following implementation, wherein these frames have transmit address (TA) or receiver address (RA) set as the MAC addresses of two P2P STAs.

The apparatus or method of any preceding or following implementation, wherein these frames carry a NAV with an end time beyond the allocation end time.

The apparatus or method of any preceding or following implementation, wherein these frames set basic NAV of intra-BSS STAs.

The apparatus or method of any preceding or following implementation, wherein the AP sends a trigger frame or MU-RTS TXS frame in the next allocation within the same TXOP for MU/SU scheduling, then if the addressed STA previously received the frames it does not respond to the trigger so as not to interfere with a perceived OBSS TXOP because the basic NAV does not indicate that the medium is idle.

The apparatus or method of any preceding or following implementation, wherein a PPDU carrying frames in a P2P allocation is required to be in a PPDU format that can identify its BSS, such as in HE or EHT format.

The apparatus or method of any preceding or following implementation, wherein a PPDU carrying frames in an allocation without BSSID/AP MLD address in its address fields, is required to set NAV, in either the preamble or frames within the PPDU, with an end time which does not extend beyond the end of the current allocation duration.

The apparatus or method of any preceding or following implementation, wherein a PPDU carrying frames in an allocation soliciting a responding PPDU which carries a frame without BSSID/AP MLD address in its address fields, is required to set NAV, in the preamble or frames within the PPDU, having an end time not greater than the end of the current allocation duration.

The apparatus or method of any preceding or following implementation, wherein all frames in an allocation duration are required to set NAV with an end time that does not extend beyond the end of the current allocation duration.

The apparatus or method of any preceding or following implementation, wherein the MU-RTS TXS frame may have a receiver address (RA) set to a unicast MAC address of a given STAx.

The apparatus or method of any preceding or following implementation, wherein other STAs in the BSS can determine that the given STAx is an intra-BSS STA, based on the RA and TA (BSSID) values in the frame.

The apparatus or method of any preceding or following implementation, wherein later in the allocation duration, frames exchanged between the given STAx and P2P peer STAy, and other intra-BSS STAs set an intra-BSS NAV based on STAx's MAC address in the address fields in the frames; wherein the intra-BSS NAV does not prevent these intra-BSS STAs from responding to subsequent trigger frames.

The apparatus or method of any preceding or following implementation, wherein the frame used for allocating P2P SP, such as MU-RTS TXS, has a NAV end time which does not extend beyond the end of the allocation duration plus a given threshold margin;

The apparatus or method of any preceding or following implementation, wherein the AP at the end of the allocation duration, transmits another frame to extend the TXOP.

The apparatus or method of any preceding or following implementation, wherein these frames have transmit address (TA) or receiver address (RA) set as the MAC addresses of two P2P STAs.

The apparatus or method of any preceding or following implementation, wherein these frames carry a NAV with an end time beyond the allocation end time.

The apparatus or method of any preceding or following implementation, wherein these frames using a MU-RTS TXS based P2P access set basic NAV of intra-BSS STAs.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly, the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for wireless communication in a network, the apparatus comprising:
(a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links;
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol in which the STA operating as an AP using multiple frame protection acquire a TXOP, and performs multiple allocations in the TXOP, comprising:
(i) setting a NAV within frames of allocation required to have a NAV end time which extends beyond the end time of the TXOP initially acquired by the AP; and
(ii) wherein said allocation can be trigger based UpLink (UL) Multi-User (MU) access or MU-RTS TXS based UL Peer-To-Peer (P2P) access.

2. The apparatus of claim 1, wherein said allocation is using a MU-RTS TXS based P2P access, in which frames are sent in a pre-HE format that do not carry a Basic Service Set Identification (BSSID) in its address fields.

3. The apparatus of claim 2, wherein these frames have transmit address (TA) or receiver address (RA) set as the MAC addresses of two P2P STAs.

4. The apparatus of claim 2, wherein these frames carry a NAV with an end time beyond the allocation end time.

5. The apparatus of claim 2, wherein these frames set basic NAV of intra-BSS STAs.

6. The apparatus of claim 1, wherein the AP sends a trigger frame or MU-RTS TXS frame in the next allocation within the same TXOP for MU/SU scheduling, then if the addressed STA previously received the frames it does not respond to the trigger so as not to interfere with a perceived OBSS TXOP because the basic NAV does not indicate that the medium is idle.

7. The apparatus of claim 6, wherein a PPDU carrying frames in a P2P allocation is required to be in a PPDU format that can identify its BSS, such as in HE or EHT format.

8. The apparatus of claim 6, wherein a PPDU carrying frames in an allocation without BSSID/AP MLD address in its address fields, is required to set NAV, in either the preamble or frames within the PPDU, with an end time which does not extend beyond the end of the current allocation duration.

9. The apparatus of claim 6, wherein a PPDU carrying frames in an allocation soliciting a responding PPDU which carries a frame without BSSID/AP MLD address in its address fields, is required to set NAV, in the preamble or frames within the PPDU, having an end time not greater than the end of the current allocation duration.

10. The apparatus of claim 6, wherein all frames in an allocation duration are required to set NAV with an end time that does not extend beyond the end of the current allocation duration.

11. The apparatus of claim 6, wherein the MU-RTS TXS frame may have a receiver address (RA) set to a unicast MAC address of a given STAx.

12. The apparatus of claim 11, wherein other STAs in the BSS can determine that the given STAx is an intra-BSS STA, based on the RA and TA (BSSID) values in the frame.

13. The apparatus of claim 12, wherein later in the allocation duration, frames exchanged between the given STAx and P2P peer STAy, and other intra-BSS STAs set an intra-BSS NAV based on STAx's MAC address in the address fields in the frames; wherein the intra-BSS NAV does not prevent these intra-BSS STAs from responding to subsequent trigger frames.

14. The apparatus of claim 6, wherein the frame used for allocating P2P SP, such as MU-RTS TXS, has a NAV end time which does not extend beyond the end of the allocation duration plus a given threshold margin.

15. The apparatus of claim 14, wherein the AP at the end of the allocation duration, transmits another frame to extend the TXOP.

16. An apparatus for wireless communication in a network, the apparatus comprising:
(a) a wireless communication circuit, performing transmission of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links;
(b) a processor coupled to said wireless communication circuit for operating on the WLAN;
(c) a non-transitory memory storing instructions executable by the processor for communicating with other STAs; and
(d) wherein said instructions, when executed by the processor, perform steps of a wireless communications protocol in which the STA operating as an AP using multiple frame protection acquire a TXOP, and performs multiple allocations in the TXOP, comprising:
(i) setting a NAV within frames of allocation required to have a NAV end time which extends beyond the end time of the TXOP initially acquired by the AP; and
(ii) wherein said allocation can be trigger based UpLink (UL) Multi-User (MU) access or MU-RTS TXS based UL Peer-To-Peer (P2P) access; and
(iii) wherein said allocation is using a MU-RTS TXS based P2P access, in which frames are sent in a pre-HE format that do not carry a Basic Service Set Identification (BSSID) in its address fields.

17. The apparatus of claim 16, wherein these frames have a transmit address (TA) or receiver address (RA) set as the MAC addresses of two P2P STAs.

18. The apparatus of claim 16, wherein these frames carry a NAV with an end time beyond the allocation end time.

19. The apparatus of claim 16, wherein these frames using a MU-RTS TXS based P2P access set basic NAV of intra-BSS STAs.

20. A method of performing wireless communication in a network, comprising:
(a) performing wireless communication of frames between the medium access control (MAC) layers of an IEEE 802.11 network as a wireless station (STA) which is a separate STA or as a STA in a multiple-link device (MLD), and operating as either a regular STA or an Access Point (AP) STA, for wirelessly communicating with other wireless stations (STAs) on a wireless local area network (WLAN) in which enhanced distributed channel access (EDCA) is utilized for random channel access on all the links, and in which the STA operating as an AP using multiple frame protection acquire a TXOP, and performs multiple allocations in the TXOP, comprising:
(b) setting a NAV within frames of allocation required to have a NAV end time which extends beyond the end time of the TXOP initially acquired by the AP; and
(c) wherein said allocation can be trigger based UpLink (UL) Multi-User (MU) access or MU-RTS TXS based UL Peer-To-Peer (P2P) access.
